(19) United States
(12) Patent Application Publication
(10) Pub. No.: US 2022/0030829 A1
(43) Pub. Date: Feb. 3, 2022

(54) SYSTEM AND METHOD FOR NO SPILLAGE DRINKING BOWL

(71) Applicant: Nduka Ejiofor Udeh, Sugarland, TX (US)

(72) Inventor: Nduka Ejiofor Udeh, Sugarland, TX (US)

(21) Appl. No.: 17/168,906

(22) Filed: Feb. 5, 2021

Related U.S. Application Data
(60) Provisional application No. 63/060,660, filed on Aug. 3, 2020.

(51) Int. Cl. A01K 7/00; A01K 5/01

(52) U.S. Cl. CPC A01K 7/005; A01K 5/0135

(57) ABSTRACT

A system and method for a no spillage pet bowl designed to hold and store large amounts of water or food as well as prevent pets such as dogs from spilling the contents across the floor, the system having two different configurations where in the first configuration the bowls may be used similar to a conventional bowl and in the second configuration a replaceable head guide may be positioned within the bowl to guide the pet into the bowl and prevent water from being displaced from the bowl.

### CROSS REFERENCE TO RELATED APPLICATIONS

The application claims priority to provisional application No. 63/060,660 filed on Aug. 3, 2020, which is incorporated in its entirety.

### FIELD OF DISCLOSURE

The field of disclosure is generally directed to pet supplies and more particularly to a drinking or feeding apparatus whereby the contents in the apparatus are controllably obtained by an animal to minimize or prevent spillage.

### BACKGROUND

Pets, especially dogs and cats, can reduce stress, anxiety, and depression, ease loneliness, encourage exercise and playfulness, and even improve your cardiovascular health. Caring for an animal can help children grow up more secure and active. Pets also provide valuable companionship for older adults. Many homes have at least one pet living inside. The pets rely on their humans to provide them the basic necessity of food and drink whereby most pets drink out of a water bowl or other apparatuses. However, many problems may arise when pets are drinking water from a water bowl; they spill water on the floor or overturn the bowl. Other bowls provide an inadequate amount of water for pets, needing to be refilled every few hours. Some pet bowls are designed to release water as needed but typically can only store limited amounts of water for the pets. The present invention applies a different approach where the pet may always have water and can drink from the container without spillage

### SUMMARY

The present invention is directed to a pet bowl including a base reservoir configured to hold a fluid, a cover, the cover connected to the base reservoir, the cover configured to cover the base reservoir when connected, the cover having an aperture, and a head guide, the head guide configured to be positioned within the aperture of the cover, the head guide when positioned not reaching the base reservoir, whereby the head guide has a flange such that the flange rests on the area surrounding the aperture, whereby the cover has a lowered plane edge portion extending downward past a bottom surface of cover piece, whereby the base reservoir has a cube shaped designed with a base portion extending into a sidewall portion, whereby the cover is rectangular in shape with a circular aperture, whereby the head guide has a bottom surface portion and a sidewall portion extends outwardly and upwardly from an upper margin of the bottom surface portion whereby the sidewall portion terminates into a top surface portion whereby the top surface portion is of a larger area or circumference than bottom surface portion.

The present invention is further directed to a pet bowl including a base reservoir configured to hold a fluid; the base reservoir having an aperture, a head guide, the head guide configured to be positioned within the aperture of the base reservoir, the head guide when positioned not reaching the base reservoir, whereby the head guide having a flange such that the flange rests on the area surrounding the aperture, whereby the base reservoir has a cone shaped designed with a base portion extending into a sidewall portion, whereby the head guide has a bottom surface portion and a sidewall portion extends outwardly and upwardly from an upper margin of the bottom surface portion whereby the sidewall portion terminates into a top surface portion whereby the top surface portion is of a larger area or circumference than the bottom surface portion.

The present invention is further directed to a method for using a pet bowl in two configurations including a regular pet bowl and a no spillage pet bowl, the method including placing a base reservoir on the ground, pouring a fluid into the base reservoir, positioning a cover onto the base reservoir, the cover having an aperture, the cover having a lowered plane edge portion extending downward past a bottom surface of cover piece that is retained on an inner surface of the base reservoir, positioning a head guide within the aperture of the cover, the head guide when positioned not reaching the base reservoir to form a no spillage pet bowl, the head guide has a flange such that the flange rests on the area surrounding the aperture.

### DESCRIPTION OF DRAWINGS

The present invention will be described by way of exemplary embodiments, but not limitations, illustrated in the accompanying drawings in which like references denote similar elements, and in which:

FIG. 1A illustrates an embodiment of the cone shaped no spillage drinking bowl.

FIG. 1B illustrates an embodiment of the cube shaped no spillage drinking bowl.

FIG. 2 illustrates the components of the cube shaped no spillage drinking bowl.

FIG. 3 illustrates the cube shaped no spillage drinking bowl in use.

FIG. 4 illustrates an embodiment of the components of the cone shaped no spillage drinking bowl.

FIG. 5 illustrates the cone shaped no spillage drinking bowl in use.

### DETAILED DESCRIPTION

In the Summary above and in this Detailed Description, and the claims below, and in the accompanying drawings, reference is made to particular features of the invention. The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined).

“Exemplary” is used herein to mean “serving as an example, instance, or illustration.” Any aspect described in this document as “exemplary” is not necessarily to be construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items” may indicate the presence of only one item or may indicate more items. Thus, the term “set” may be equivalent to “one or more” as used herein.

In the following detailed description, numerous specific details are set forth in order to provide a more thorough understanding of the one or more embodiments described herein. However, it will be apparent to one of ordinary skill in the art that the invention may be practiced without these specific details. In other instances, well-known features have not been described in detail to avoid unnecessarily complicating the description.

The present disclosure is generally drawn to a system and method, according to one or more exemplary embodiments, for a no spillage pet bowl designed to hold and store large amounts of water or food as well as prevent pets such as dogs from spilling the contents across the floor. The invention is designed to be very versatile adapting for different types of living spaces. The invention may be used in two different configurations where in the first configuration the bowls may be used similar to a conventional bowl and in the second configuration a replaceable head guide may be positioned within the bowl to guide the pet into the bowl and prevent water from being displaced from the bowl.

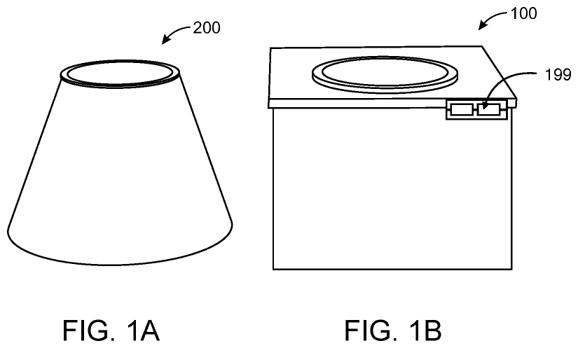

With reference now to FIG. 1, an exemplary embodiment of a cube shaped pet bowl 100 and cone shaped pet bowl 200 are shown. It should be appreciated that these shapes are non-limiting and the pet bowls may be constructed in other shapes such as a rectangular prism, hexagonal prism, octagonal prism, a cylinder, a sphere, or a disc, etc. Cube shaped pet bowl 100 and cone shaped pet bowl 200 may be made of a stable material such as wood, plastic, metal, or other composites or materials structured to withstand pressure from a pet moving the bowls around.

In some embodiments, cube shaped pet bowl 100 and cone shaped pet bowl 200 may have weights positioned at the bottom to further prevent movement. Cube shaped pet bowl 100 and cone shaped pet bowl 200 may be attached to stabilizing feet 227 to contact the ground and minimize slippage. Stabilizing feet 227 may be made of a moldable rubber or rubber-like plastic material. In some examples, optional attachments for different stabilizing feet may accommodate different types of ground surfaces, such as dirt, sand, and pavement. In further non-limiting embodiments, stabilizing feet may have holes for accepting coned ended studs used to further grip the surface the cube based embodiment is placed upon.

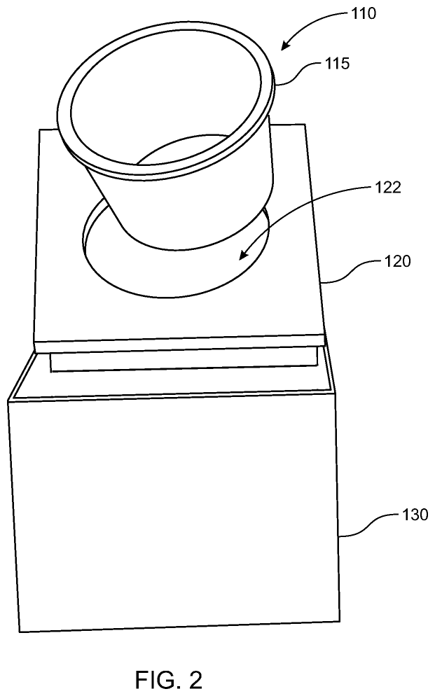

As illustrated in FIG. 2, the main components of dispenser 100 include a head guide 110, cover 120, and base 130. Base 130 is cube in shape and supports cube shaped pet bowl 100 in an upright position on a supporting surface such as a floor or table. Base 130 may have an inner chamber or empty space that extends into base 130 between the inner walls of base 130 to receive fluid from an external source and hold fluid until the fluid is consumed by a pet. Base 130 may be filled with fluid up to a specific height. Fluid may be but is not limited to water, juices, and creams. The inner chamber may also hold other contents such as food or toys.

Base 130 may have a bottom surface portion, whereby when placed on a support, bottom surface portion comes into contact with the supporting surface. Cube shaped pet bowl 100 as a whole, may be symmetric about a horizontal and vertical axis passing through the middle of cube shaped pet bowl 100 perpendicular to the bottom surface portion and a supporting surface. However in other embodiments pet bowl 100 may be asymmetrical in shape. A sidewall portion extends directly upward from an upper margin of the bottom surface portion. The sidewall portion then extends upward into an open top element allowing access to the inner chamber.

Cover 120 may be square in shape with a top surface, bottom surface, and a series of sidewalls extending between the top surface and bottom surface. Cover 120 may have an aperture 122 passing through an area of cover 120 such that fluid may move down through aperture 122 to base 130, causing fluid to flow into the inner chamber.

Cover piece 120 may have a lowered plane edge portion extending downward past the bottom surface of cover piece 120. The edge portion is configured to be retained in the interior chamber of base 130. Cover 120 and base 130 may also be affixed to one another with, for example, fasteners, adhesive, latches, hinges, welding techniques, or any other method known to those skilled in the art.

Head guide 110 may be hollow with an aperture passing through head guide 110. Head guide 110 may have a bottom surface portion. A sidewall portion extends outwardly and upwardly from an upper margin of the bottom surface portion whereby the sidewall portion terminates into a top surface portion whereby the top surface portion may be a larger area or circumference than bottom surface portion. In some embodiments, the sidewall portion may have no angle or be at any different angle.

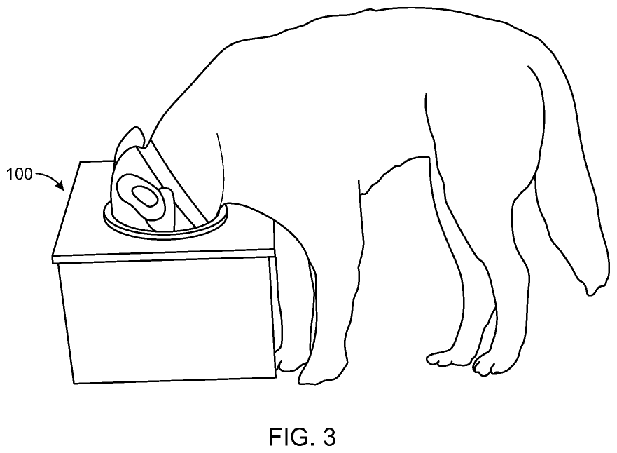

Head guide 110 may include a radially extending, flanged, or stepped region, such as flange 115, near the top surface portion of head guide 110. Flange 115 may have a diameter greater than the diameter of aperture 122 of cover 120. Flange 115 on head guide 110 may be configured to contact and rest against the top surface of cover 120 (e.g. across the outer edges of aperture 122) whereby when head guide 110 is positioned on cover 120, the bottom surface portion of head guide 110 does not reach the bottom of base 130. Head guide 110 is shaped and dimensioned to guide the pet into base 130 to access a limited amount of fluid without spillage as illustrated in FIG. 3.

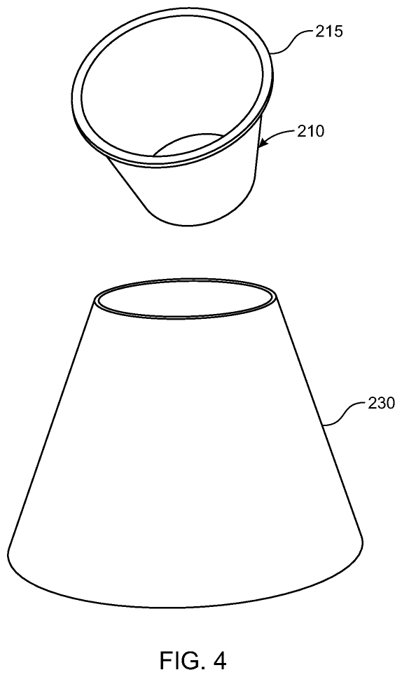

As illustrated in FIG. 4, the main components of cone shaped pet bowl 200 include a head guide 210 and base 230. Base 230 is cone in shape and supports cone shaped pet bowl 200 in an upright position on a supporting surface such as a floor or table. Base 230 may have an inner chamber or empty space that extends into base 230 between the inner walls of base 230 to receive fluid from an external source and hold fluid until the fluid is consumed by a pet.

Base 230 may have a bottom surface portion, whereby when placed on a supporting surface, the bottom surface portion comes into contact with the supporting surface. Cone shaped pet bowl 200 as a whole, is generally symmetric about a horizontal and vertical axis passing through the middle of cone shaped pet bowl 200 perpendicular to the bottom surface portion and the supporting surface. A sidewall portion extends directly upward and inward from an upper margin of the bottom surface portion. The sidewall portion then extends upward into an open top surface portion allowing access to the inner chamber whereby the bottom surface portion is of a larger area or circumference than the top surface portion.

Head guide 210 may be hollow with an aperture passing through head guide 210. Head guide 210 may have a bottom surface portion. A sidewall portion extends outwardly and upwardly from an upper margin of bottom surface portion whereby the sidewall portion terminates into a top surface portion whereby the top surface portion is of a larger area or circumference than the bottom surface portion. In some embodiments, the sidewall portion may have no angle or be at any different angle.

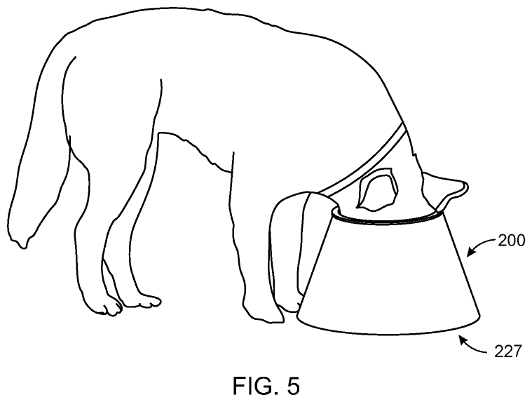

Head guide 210 may include a radially extending, flanged, or stepped region, such as flange 215, near the top surface portion or of head guide 210. Flange 215 may have a diameter greater than the diameter of the open top surface portion of head guide 210. Flange 215 on head guide 210 may be configured to contact and rest against the top surface of base 230 whereby when head guide 210 is positioned on base 230, the bottom surface portion of head guide 210 does not reach the bottom of base 230. Head guide 210 is shaped and dimensioned to guide the pet into base 230 to access a limited amount of fluid without spillage as illustrated in FIG. 5.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the use contemplated.

1. A pet bowl comprising:
a base reservoir, the base reservoir having an inner reservoir for holding fluid, the inner reservoir extending from a top to a bottom of the base reservoir;
a cover, the cover connected to the base reservoir, the cover configured to cover the base reservoir when connected, the cover having an aperture; and
a head guide having an aperture therethrough, wherein the head guide is positioned within the aperture of the cover, the head guide when positioned not reaching the bottom of the base reservoir, wherein when the head guide is positioned within the base reservoir the head guide provides access to an entirety of fluid in the base reservoir is accessible without movement of any part of the pet bowl.

2. The pet bowl of claim 1 wherein the head guide has a flange such that the flange rests on an area surrounding the aperture.

3. The pet bowl of claim 2 wherein the cover has a lowered plane edge portion extending downward past a bottom surface of the cover, the lowered plane edge portion positioned within an inner surface of the base reservoir, the cover having an edge perimeter portion extending outward from and not connected to the base reservoir, an entirety of the edge perimeter portion positioned above the base reservoir when the cover is connected to the base reservoir.

4. The pet bowl of claim 3 wherein the base reservoir has a cube shaped designed with a base portion extending into a sidewall portion wherein the inner reservoir is cube shaped.

5. The pet bowl of claim 4 wherein the cover has a first position positioned on top of the base reservoir wherein the fluid is only accessible by the head guide and a second position wherein the cover is lifted upward off the base reservoir wherein the fluid is accessible from above the base reservoir.

6. The pet bowl of claim 5 wherein the head guide has a bottom surface portion and a sidewall portion which extends outwardly and upwardly from an upper margin of the bottom surface portion wherein the sidewall portion terminates into a top surface portion wherein the top surface portion is of a larger area or circumference than the bottom surface portion wherein the aperture increases in size from the bottom surface portion to the top surface portion.

7. The pet bowl of claim 6 is made of wood.

8. (canceled)

9. The pet bowl of claim 1 further comprising one or more latches to hold the cover to the base reservoir.

10. A pet bowl comprising:
a base reservoir configured to hold a fluid; the base reservoir having an aperture; and
a head guide, the head guide positionalable within the aperture of the base reservoir wherein nothing is positioned inside of the head guide, the head guide when positioned not reaching a bottom of the base reservoir, the base reservoir having a reservoir for holding fluid, an entirety of the reservoir Tillable with water.

11. The pet bowl of claim 10 wherein the head guide having a flange such that the flange rests on an area surrounding the aperture.

12. The pet bowl of claim 11 wherein the base reservoir has a cone shaped designed with a base portion extending into a sidewall portion.

13. The pet bowl of claim 12 wherein the head guide has a bottom surface portion and a sidewall portion extends outwardly and upwardly from an upper margin of the bottom surface portion wherein the sidewall portion terminates into a top surface portion wherein the top surface portion is of a larger area or circumference than bottom surface portion.

14. The pet bowl of claim 13 made of stable material such as wood, plastic, or metal.

15. The pet bowl of claim 13 further comprising stabilizing feet to contact the ground and minimize slippage.

16. The pet bowl of claim 13 further comprising one or more fasteners to hold the head guide to the base reservoir.

17. A method for using a pet bowl in two configurations including a regular pet bowl and a no spillage pet bowl, the method comprising:
placing a base reservoir on the ground;
pouring a fluid into the base reservoir; and
positioning a cover onto the base reservoir, the cover having an aperture, the cover having a lowered plane edge portion extending downward past a bottom surface of the cover that is retained on an inner surface of the base reservoir.

18. The method of claim 17 further comprising: positioning a head guide within the aperture of the cover, the head guide when positioned not reaching the base reservoir to form a no spillage pet bowl, the head guide has a flange such that the flange rests on the area surrounding the aperture.

19. The method of claim 18 further comprising fastening the base reservoir to the cover by one or more fasteners.

20. The method of claim 18 further comprising removing the head guide and the cover to form the regular pet bowl.

21. A pet bowl comprising:
a base reservoir that is hollow and cube in shape, the base reservoir having an inner reservoir for holding fluid, the inner reservoir extending from a top to a bottom of the base reservoir;
a cover that is square in shape having a circular aperture at a center, the cover removably connected to the base reservoir such that when the cover is connected to the base reservoir, the fluid is escapable only through the circular aperture and when not connected, the cover having an edge perimeter portion extending outward from and not connected to the base reservoir, an entirety of the edge perimeter portion positioned above the base reservoir when the cover is connected to the base reservoir, wherein the cover has a lowered plane edge portion extending downward past a bottom surface of the cover, the lowered plane edge portion positioned within an inner surface of the base reservoir when the cover is connected to the base reservoir; and
a head guide having a circular aperture therethrough, wherein the head guide is positioned within the circular aperture of the cover, wherein the circular aperture of the head guide increases in size from a bottom surface portion to a top surface portion, wherein the head guide has a bottom surface portion and a sidewall portion extends outwardly and upwardly from an upper margin of the bottom surface portion wherein the sidewall portion terminates into a top surface portion wherein the top surface portion is of a larger area or circumference than the bottom surface portion wherein the aperture increases in size from the bottom surface portion to the top surface portion, wherein a pathway from a top of the circular aperture to a bottom of the base resevoir is unobstructed.
